(19) United States
(12) Patent Application Publication
(10) Pub. No.: US 2026/0243861 A1
(43) Pub. Date: Aug. 20, 2026

(54) GEOLOCATION OF DIGITAL WIRELESS SIGNALS VIA REMODULATED SIDE-CHANNEL

(71) Applicant: L3Harris Technologies, Inc., Melbourne, FL (US)

(72) Inventors: Jeffrey D. BARNES, Dallas, TX (US); Mia KIM, Garland, TX (US); Ryan J. STEED, Rockwall, TX (US)

(21) Appl. No.: 19/053,755

(22) Filed: Feb. 14, 2025

(51) Int. Cl. G01S 5/02; G01S 5/06; H04W 64/00

(52) U.S. Cl. CPC G01S 5/0252; G01S 5/06; H04W 64/006

(57) ABSTRACT

A method of geolocating a wireless transmitter comprises: by each of multiple RF collectors, receiving a modulated RF signal transmitted by the wireless transmitter, and converting the modulated RF signal to a channel of in-phase/quadrature (I/Q) data, such that the multiple RF collectors produce corresponding ones of multiple channels of the I/Q data; by a side-channel RF collector, receiving the modulated RF signal, and converting the modulated RF signal to remodulated reference I/Q data; correlating the remodulated reference I/Q data against the corresponding ones of the multiple channels of the I/Q data to produce correlation peaks for the corresponding ones of the multiple channels of the I/Q data; and determining a geolocation of the wireless transmitter based on information related to the correlation peaks.

### TECHNICAL FIELD

The present disclosure relates generally to geolocation techniques.

### BACKGROUND

A geolocation system may produce geolocation measurements on an emitter-of-interest based on a wireless signal transmitted by the emitter. For example, a geolocation system utilizes signal collection and processing to obtain geolocation estimates on the emitter based on receipt of the wireless signal by the geolocation system. A conventional geolocation system may fail to provide meaningful geolocation measurements on the emitter for several reasons. First, the received signal power for the wireless signal transmitted by the emitter may fall below a detection threshold due to a long range between the geolocation system and the emitter (and thus a high free-space path loss between the two) or due to insufficient antenna gain. Second, a dense radio frequency (RF) interference environment may inhibit proper parameter estimation on the wireless signal transmitted by the emitter. Third, the geolocation system may be unable to use knowledge of an underlying signal structure or content of the wireless signal in order to produce geolocation measurements.

### BRIEF DESCRIPTION OF THE DRAWINGS

FIG. 1 is an illustration of an example communication environment that includes a wireless transmitter and a geolocation system spaced-apart from the wireless transmitter and configured to perform geolocation.

FIG. 2A is a block diagram of an example collector receiver representative of a side-channel receiver and a collector receiver.

FIG. 2B is a block diagram of an example wireless datalink that may be used for wireless transmission of channel in-phase (I)/quadrature (Q) (I/Q) data.

FIG. 3 is a block diagram of an example geolocation processor.

FIG. 4 is a flowchart of an example method of geolocating performed by the geolocation system.

FIG. 5 shows an example complex ambiguity function (CAF) that correlates a channel of I/Q data against remodulated reference I/Q data to produce CAF results.

FIG. 6 shows an example generalized CAF that performs separate correlations of remodulated reference data against a channel of I/Q data over both frequency and time to produce a CAF result.

FIG. 7 shows a plot of an example CAF result.

FIG. 8 shows example peak processing operations performed by the geolocation processor on CAF results corresponding to RF collectors of the geolocation system.

FIG. 9 shows example inputs to a time-difference-of-arrival (TDOA)/frequency-difference-of-arrival (FDOA) geolocation algorithm performed by the geolocation processor.

FIG. 10 is a flowchart of another example method of geolocating a wireless transmitter performed by a geolocation system.

FIG. 11 is a block diagram of an example controller configured to perform operations described herein.

### DESCRIPTION

### Overview

In an embodiment, a method of geolocating a wireless transmitter comprises: by each of multiple RF collectors, receiving a modulated RF signal transmitted by the wireless transmitter, and converting the modulated RF signal to a channel of in-phase/quadrature (I/Q) data, such that the multiple RF collectors produce corresponding ones of multiple channels of the I/Q data; by a side-channel RF collector, receiving the modulated RF signal, and converting the modulated RF signal to remodulated reference I/Q data; correlating the remodulated reference I/Q data against the corresponding ones of the multiple channels of the I/Q data to produce correlation peaks for the corresponding ones of the multiple channels of the I/Q data; and determining a geolocation of the wireless transmitter based on information related to the correlation peaks.

### Example Embodiments

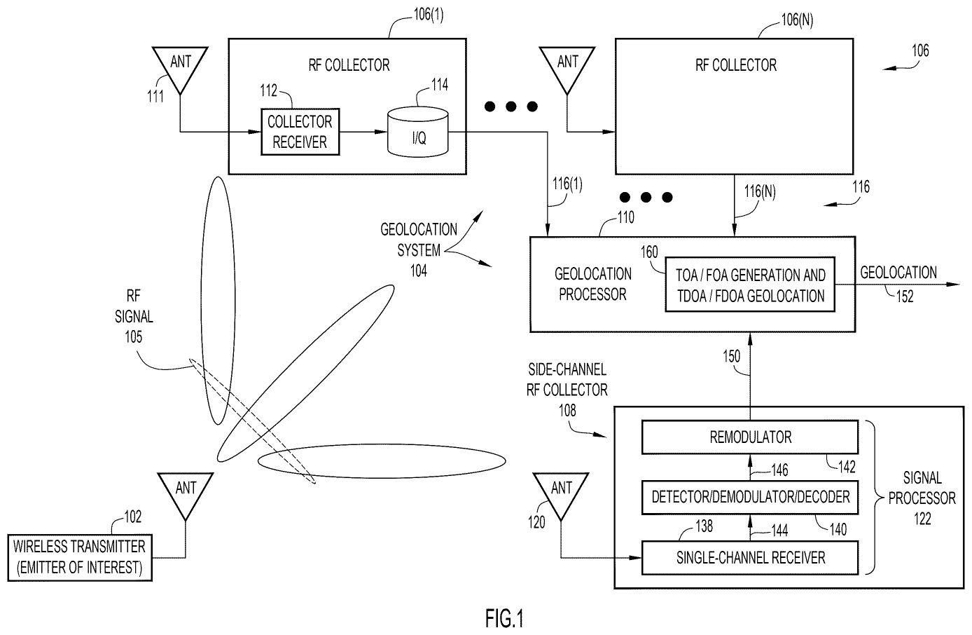

FIG. 1 is an illustration of an example communication environment that includes a wireless transmitter 102 (also referred to as an “emitter”) and a geolocation system 104 spaced-apart from the wireless transmitter and configured to perform geolocation according to embodiments presented herein. Wireless transmitter 102 receives and packetizes a data stream to produce data in the form of data packets. Wireless transmitter 102 typically adds to the data wireless transmitter identifiers, such as an Internet Protocol (IP) address, a media access control (MAC) address, and other identifiers, for example. Wireless transmitter 102 encodes the data and adds a checksum and/or a cyclic redundancy check (CRC) to the data to produce encoded data, which may be formatted as an encoded data packet. Wireless transmitter 102 digitally modulates the encoded data to produce digitally modulated data, which may be packetized into digitally modulated data packets. Wireless transmitter 102 may digitally modulate the data using any known or hereafter developed digital modulation technique, including but not limited to, frequency-division multiplexing (OFDM), direct sequence (DS) spread spectrum (DSSS), quadrature amplitude modulation (QAM), phase-shift keying (PSK), and the like.

Wireless transmitter 102 may add a preamble to the digitally modulated data. For example, wireless transmitter 102 may prepend the preamble to the digitally modulated packets. Wireless transmitter 102 frequency up-coverts the digitally modulated data with the preambles to a (digitally) modulated RF signal, and transmits the same as modulated RF signal 105. Modulated RF signal 105 conveys the digitally modulated data, which may be packetized. In an example, wireless transmitter 102 may be a relatively low power transmitter that transmits modulated RF signal 105 at a relatively low power level. Examples of wireless transmitter 102 may include a Wi-Fi, Bluetooth, or cellular user-equipment (UE) transmitter (e.g., for a Universal Mobile Telecommunication Service (UMTS), Long-Term Evolution (LTE), 5G-New Radio (NR), and the like).

Geolocation system 104 includes RF collectors 106(1)-106(N) (collectively referred to as “RF collectors 106” and also referred to as “RF co-collectors”), a side-channel RF collector 108, and a geolocation processor 110 all geographically separated from wireless transmitter 102. In an example, RF collectors 106 (also referred to as “RF signal collectors”), side-channel RF collector 108 (also referred to as a “side-channel RF signal collector”), and geolocation processor 110 are deployed or hosted on respective mobile and/or fixed platforms that are geographically separated from, and move relative to, each other. For example, RF collectors 106 and side-channel RF collector 108 may be deployed on separate flying (e.g., airborne or spaceborne) platforms, terrestrial platforms, or a combination of both. Similarly, geolocation processor 110 may be deployed on a separate flying or terrestrial platform.

At a high level, RF collectors 106 and side-channel RF collector 108 concurrently receive modulated RF signal 105 transmitted by wireless transmitter 102, concurrently process the modulated RF signal to produce respective signal processing results (described below), and concurrently provide the same to geolocation processor 110. Geolocation processor 110 computes a geolocation of wireless transmitter 102 (i.e., geolocates the wireless transmitter) based on the signal processing results. Geolocation system 104 is now described in further detail.

In an example, RF collectors 106 may be considered “long-range” RF collectors that are separated from wireless transmitter 102 by a long distance. RF collectors 106 are configured similarly to each other, and the following description of RF collector 106(1) shall suffice for the other RF collectors. RF collector 106(1) includes an antenna 111, a collector receiver 112, and a data store 114. In an example, antenna 111 may be configured as a relatively low-gain omnidirectional antenna array. Antenna 111 receives RF energy including modulated RF signal 105 along with undesired noise and interference, and delivers the same to collector receiver 112. Antenna 111 delivers modulated RF signal 105 to collector receiver 112 with a relatively low signal-to-noise ratio (SNR), given the low omnidirectional gain of the antenna and/or the long distance between wireless transmitter 102 and RF collector 106(1).

Collector receiver 112 is tuned to a center frequency of modulated RF signal 105, and frequency down-converts the modulated RF signal to a channel of I/Q data 116(1) without detecting, digitally demodulating, and decoding the digitally modulated data conveyed by the modulated RF signal. Collector receiver 112 stores the channel of I/Q data 116(1) in data store 114, from which RF collector 106(1) sends the channel of I/Q data to geolocation processor 110. RF collector 106(1) may wirelessly transmit the channel of I/Q data 116(1) to geolocation processor 110 over a wireless datalink, for example. The term “I/Q”

RF collectors 106(1)-106(N) concurrently operate on modulated RF signal 105 to produce multiple channels of I/Q data 116(1)-116(N) (also referred to as “multiple channels of I/Q data 116”), and concurrently send the same to geolocation processor 110. Multiple channels of I/Q data 116 convey/represent the digitally modulated data with preambles generated and transmitted by wireless transmitter 102, as described above. The digitally modulated data may be represented in each of multiple channels of I/Q data 116(i) with a relatively low SNR along with the undesired noise and interference.

Side-channel RF collector 108 is now described. In an example, side-channel RF collector 108 may be considered a “short-range” collector that is separated a short distance from wireless transmitter 102 that is less than the long distances between RF collectors 106 and wireless transmitter 102. Side-channel RF collector 108 includes a side-channel antenna 120 and a (side-channel) signal processor 122. Signal processor 122 includes a side-channel receiver 138 fed by side-channel antenna 120, a detector/demodulator/decoder 140, and a remodulator 142. Side-channel antenna 120 may be a high-gain directional antenna with a main gain lobe pointed toward wireless transmitter 102. Side-channel antenna 120 receives, and feeds to side-channel receiver 138, RF energy to include modulated RF signal 105. Given the higher selectivity of side-channel antenna 120 compared to that of the antennas (e.g., antenna 111) of RF collectors 106, and the close proximity of the side-channel antenna to wireless transmitter 102, the side-channel antenna delivers modulated RF signal 105 to side-channel receiver 138 with a higher SNR than the lower SNRs of the modulated RF signals that the antennas of RF collectors 106 deliver to their respective collector receivers.

Side-channel receiver 138 converts modulated RF signal 105 delivered by side-channel antenna 120 to a side-channel of I/Q data 144 (also referred to as an I/Q side-channel), and provides the same to detector/demodulator/decoder 140. Side-channel of I/Q data 144 represents the digitally modulated data with preambles that is generated and transmitted by wireless transmitter 102, as described above. The digitally modulated data conveyed by side-channel of I/Q data 144 may have a higher SNR than the digitally modulated data conveyed by each of multiple channels of I/Q data 116.

Detector/demodulator/decoder 140 performs the following sequence of receiver/signal processing operations on the (received) digitally modulated data with preambles (e.g., on each of the digitally modulate data packets with preambles) of side-channel of I/Q data 144:
a. Detect the digitally modulated data (or packetized data) based on the preamble. For example, correlate the side-channel of I/Q data 144 against a predetermined preamble that matches the preamble prepended to digitally modulated data in order to detect the digitally modulated data, and identify a start of the digitally modulated data (e.g., the start of a digitally modulated data packet). In some examples, the detection operation may be optional and may be skipped.
b. Once detected, digitally demodulate the digitally modulated data to yield or produce demodulated data that includes the encoded data with the checksum and/or CRC.
c. Decode the encoded data and verify the checksum and/or CRC to produce data (e.g., a data packet) that is verified. Parse the data to access the wireless transmitter identifiers.

An advantage of detecting, demodulating, and decoding side-channel I/Q data 144 is that the side-channel I/Q data may have a relatively high SNR, which increases the likelihood of recovering accurate data from the process. Detector/demodulator/decoder 140 sends to remodulator 142 combined data 146 including a stream of demodulated, decoded, and verified data (e.g., data packets) along with the wireless transmitter identifiers.

Employing the same digital modulation technique used by wireless transmitter 102 to produce modulated RF signal 105 (e.g., OFDM, DSSS, QAM, PSK, and the like), remodulator 142 digitally modulates (i.e., remodulates) the data supplied by detector/demodulator/decoder 140, to produce a stream or channel of remodulated reference I/Q data 150, and provides the same to geolocation processor 110. Remodulated reference I/Q data 150 represents denoised and verified digitally modulated I/Q data that serves as a clean reference for subsequent processing. That is, remodulated reference I/Q data 150 provides a denoised representation of modulated RF signal 105. Remodulator 142 associates the transmitter identifiers to remodulated reference I/Q data 150 as metadata, and provides both the remodulated reference I/Q data and the metadata to geolocation processor 110. Side-channel RF collector 108 may wirelessly transmit remodulated reference I/Q data 150 to geolocation processor 110 over a datalink.

Geolocation processor 110 concurrently receives the stream of remodulated reference I/Q data 150 and multiple channels of I/Q data 116. Geolocation processor 110 includes time-of-arrival (TOA)/frequency-of-arrival (FOA) generation and time-difference-of-arrival (TDOA)/frequency-difference-of-arrival (FDOA) geolocation operations 160 that determine a geolocation 152 of wireless transmitter 102 based on remodulated reference I/Q data 150 and multiple channels of I/Q data 116.

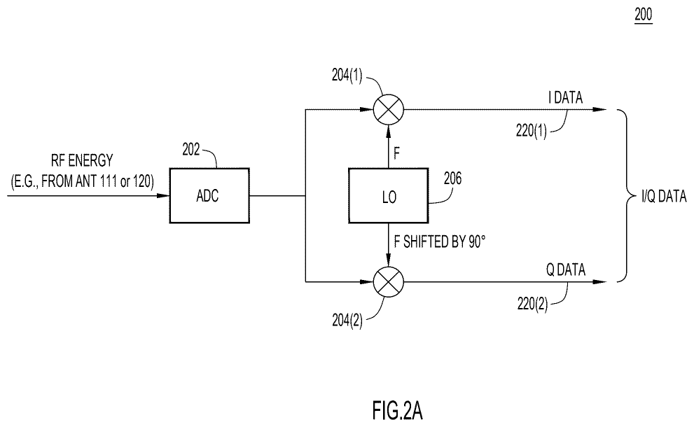

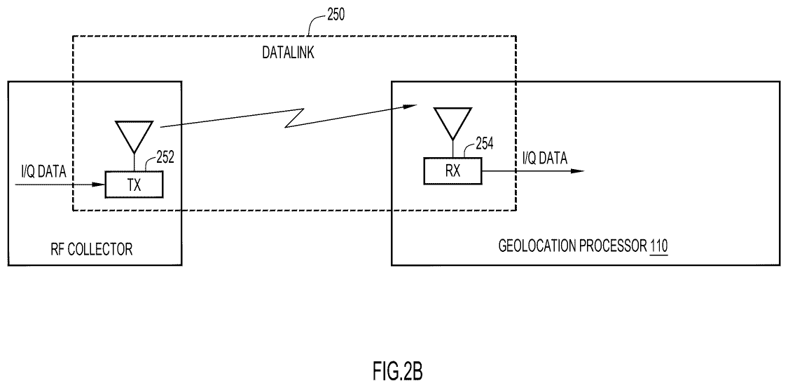

FIG. 2A is a block diagram of an example collector receiver 200 representative of side-channel receiver 138 and collector receiver 112. Collector receiver 200 includes an analog-to-digital converter (ADC) 202, an in-phase mixer 204(1), a quadrature mixer 204(2), and a local oscillator (LO) 206. In the example, in-phase mixer 204(1), quadrature mixer 204(2), and LO 206 all operate in the digital domain. ADC 202 receives from an RF collector antenna (e.g., antenna 111 or 120) RF energy that includes modulated RF signal 105, digitizes the RF energy to produce a digitized RF signal, and provides the same in parallel to in-phase mixer 204(1) and quadrature mixer 204(2). LO 206 generates an in-phase LO frequency F and provides the same to in-phase mixer 204(1). LO 206 includes a 90° phase shifter (not shown) to generate a quadrature LO signal that is shifted in phase from the in-phase LO signal by 90°, and provides the quadrature LO signal (F-90°) to mixer 204(2).

Mixer 204(1) frequency down-converts the digitized RF signal to digitized baseband in-phase (I) data 220(1) based on in-band LO signal. Similarly, mixer 204(1) frequency down-converts the digitized RF signal to digitized baseband quadrature (Q) data 220(2) based on the quadrature LO frequency. In-phase data 220(1) and quadrature data 220(2) together represent digitized baseband I/Q data for the given channel. In an alternative example in which in-phase mixer 204(1), quadrature mixer 204(2), and LO 206 all operate in the analog domain, ADC 202 is replaced by parallel ADCs in-line with the outputs of in-phase mixer 204(1) and quadrature mixer 204(2).

FIG. 2B is a block diagram of an example wireless datalink 250 that may be used for wireless transmission of channel I/Q data (e.g., channel of I/Q data 116(i) or remodulated reference I/Q data 150) from a platform that hosts an RF collector (e.g., RF collector 106(i) or side-channel RF collector 108) to a platform that hosts geolocation processor 110. Wireless datalink 250 includes a wireless transmitter (TX) 252 hosted on the RF collector and a wireless receiver (RX) 254 hosted on or near to geolocation processor 110. Wireless transmitter 252 transmits the channel of I/Q data over-the-air or over a satellite-relay link, for example. Wireless receiver 254 receives the transmitted channel of I/Q data and provides the received data to processing operations of geolocation processor 110.

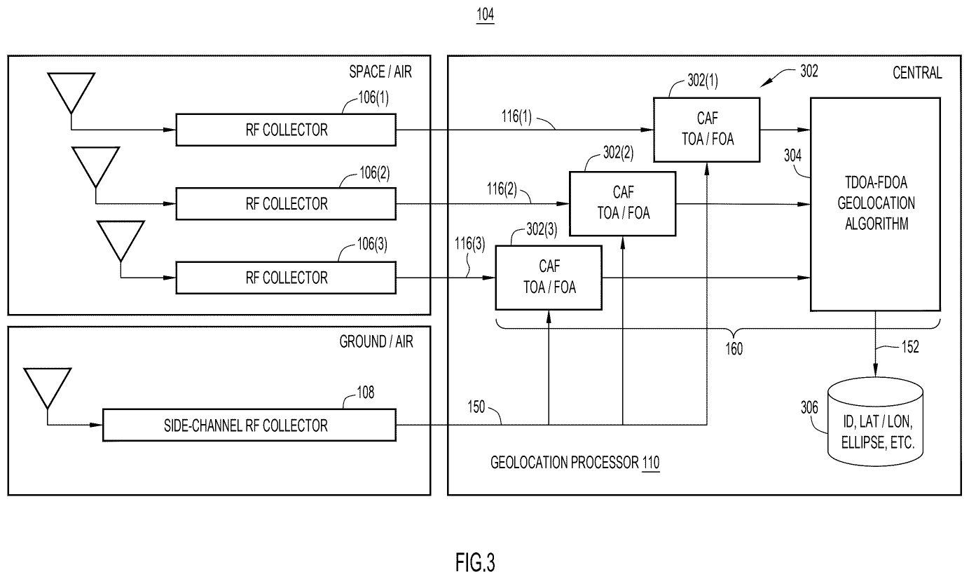

FIG. 3 is a block diagram of geolocation processor 110 according to an embodiment. In the example, geolocation system 104 includes three RF collectors 106(1), 106(2), and 106(3) deployed on respective (separate) spaceborne or airborne platforms. RF collectors 106(1), 106(2), and 106(3) receive modulated RF signal 105, convert the same to multiple channels of I/Q data 116(1), 116(2), and 116(3), and provide the three channels of I/Q data to geolocation processor 110, which may be deployed on a central platform on the ground or air, for example. Additionally, side-channel RF collector 108, which may be deployed on a ground or an airborne platform, receives modulated RF signal 105, converts the same to remodulated reference I/Q data 150, and provides the same to geolocation processor 110.

Geolocation processor 110 includes complex ambiguity functions (CAFs) 302(1)-302(3) (collectively referred to as CAFs 302), a module that implements a TDOA-FDOA geolocation algorithm 304, and a geolocation data store 306. In the example, CAFs 302 are considered off-collector processing because the CAFs are hosted on a platform separate from RF collectors 106. In another example, CAFs 302(1)-302(3) may be hosted on the same platforms that host RF collectors 106(1)-106(3), in which case the CAFs are considered on-collector processing. As used herein, a “CAF” refers to a two-dimensional (2D) autocorrelation of modulated RF signal 105 in both time and frequency, to produce amplitude and phase information. The CAF allows simultaneous estimates of TOA/TDOA and FOA/FDOA for two signals. The term CAF may refer to a module that performs CAF operations or the operations themselves.

CAFs 302(1)-302(3) individually/separately (i) correlate remodulated reference I/Q data 150 against corresponding ones of multiple channels of I/Q data 116(1)-116(3) to produce corresponding correlation peaks, (ii) identify the corresponding correlation peaks per channel, and (iii) derive corresponding TOA and FOA pairs/tuples per channel from the correlation peaks. CAFs 302(1)-302(3) provide respective TOA, FOA pairs (i.e., a TOA and an FOA per channel of I/Q data/RF collector) to TDOA-FDOA geolocation algorithm 304. The correlation peaks, time-of-arrivals (TOAs), and frequency-of-arrivals (FOAs) are collectively referred to as “correlation results” or “CAF results.” As used herein, the terms “CAF” and “correlation” may be used interchangeably.

TDOA-FDOA geolocation algorithm 304 differences pairs of the TOAs (i.e., performs differencing of the TOAs) to produce time-difference-of-arrivals (TDOAs), differences pairs of the FOAs (i.e., performs differencing of the FOAs) to produce frequency-difference-of-arrivals (FDOAs), and determines geolocation 152 of wireless transmitter 102 including a longitude and a latitude (i.e., geolocates the wireless transmitter) based on the TDOAs and the FDOAs. TDOA-FDOA geolocation algorithm 304 stores the result in geolocation data store 306.

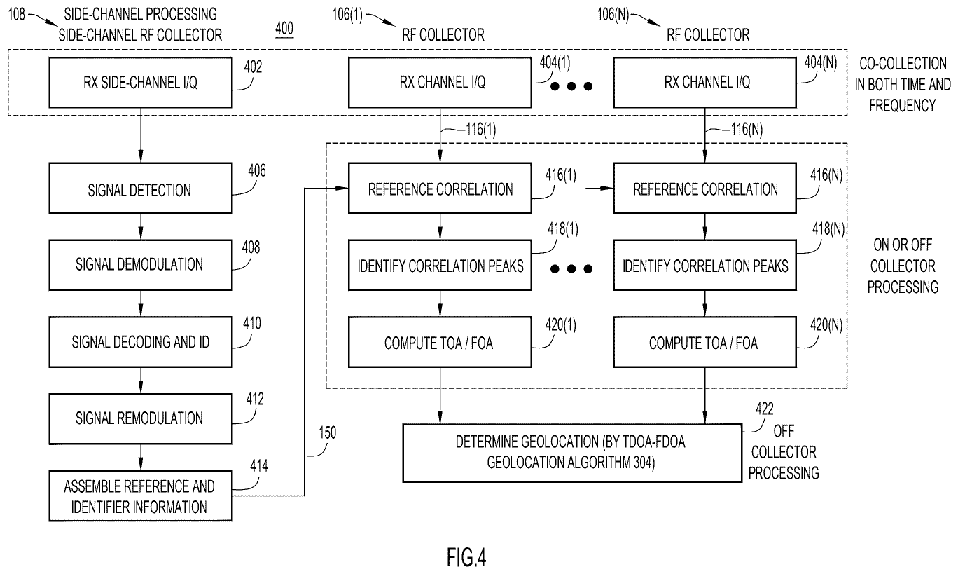

FIG. 4 is a flowchart of an example method 400 of geolocating performed by geolocation system 104. Method 400 performs concurrent RF energy collection and conversion operations to deliver I/Q data to subsequent operations. Specifically, at 402, side-channel antenna 120 receives modulated RF signal 105 that conveys digitally modulated encoded data, and provides the received modulated RF signal to side-channel receiver 138. Side-channel receiver 138 converts the (received) modulated RF signal 105 to a side-channel of (modulated) I/Q data (e.g., digitized baseband I/Q data), which also conveys the digitally modulated encoded data. In other words, the I/Q data is not demodulated.

RF collectors 106(1)-106(N) concurrently perform operations 404(1)-404(N) on modulated RF signal 105 to produce channels of I/Q data 116(1)-116(N). Operations 404(1)-404(N) are similar to each other. Therefore, the following description of operation 404(1) shall suffice for the similar operations. At 404(1), antenna 111 receives modulated RF signal 105 and provides the received signal to collector receiver 112. Collector receiver 112 converts the received signal to the channel of (modulated) I/Q data 116(1) (e.g., digitized baseband I/Q data), which conveys the digitally modulated encoded data. In this example, the multichannel I/Q data is not demodulated.

Returning to the side-channel processing, at 406, detector/demodulator/decoder 140 detects the digitally modulated encoded data conveyed by the side-channel of I/Q data, to produce detected digitally modulated encoded data.

At 408, detector/demodulator/decoder 140 digitally demodulates the detected digitally modulated encoded data, to produce or recover (demodulated) encoded data.

At 410, detector/demodulator/decoder 140 decodes the encoded data to produce data (i.e., demodulated data) and recovers transmitter identifiers (IDs) from the data. The decoding process verifies that the (demodulated) data is correct using a cyclic redundancy check (CRC), for example.

At 412, remodulator 142 digitally modulates the data from 410 to produce remodulated reference I/Q data.

At 414, remodulator 142 assembles together the remodulated reference I/Q data with metadata that includes the transmitter identifiers.

Geolocation processor 110 determines geolocates wireless transmitter 102 according the following operations performed by CAFs 302 and TDOA-FDOA geolocation algorithm 304.

At 416(1)-416(N) (performed by/using CAFs 302(1)-302(N)), geolocation processor 110 correlates the remodulated reference I/Q data against each of the multiple channels of I/Q data 116(1)-116(N) to produce correlation peaks indicative of TOAs and FOAs for corresponding ones of the multiple channels of I/Q data. In an example, CAFs 302(1)-302(N) perform correlating without correlating any of multiple channels of I/Q data 116(1)-116(N) against each other.

At 418(1)-418(N) (performed by CAFs 302(1)-302(N)), geolocation processor 110 detects/identifies the correlation peaks for the multiple channels of the I/Q data 116(1)-116(N).

At 420(1)-420(N) (performed by CAFs 302(1)-302(N)), geolocation processor 110 determines a TOA and an FOA corresponding to each correlation peak. That is, geolocation processor 110 determines TOA, FOA tuples for corresponding ones of multiple channels of I/Q data 116(1)-116(N) (and thus for RF collectors 106(1)-106(N). Another example includes an additional CAF (not shown) that correlates side-channel of I/Q data 144 against remodulated reference I/Q data 150, to produce an additional correlation peak and TOA/FOA used for subsequent processing described below. The additional CAF may be implemented in side-channel RF collector 108 or in geolocation processor 110.

At 422 (performed TDOA-FDOA geolocation algorithm 304), geolocation processor 110 generates TDOAs from the TOAs and FDOAs from the FOAs, and determines the geolocation of wireless transmitter 102 based on the TDOAs and FDOAs. Geolocation processor 110 stores the geolocation and the wireless transmitter ID, and reports the geolocation and the wireless transmitter ID to a user. For example, geolocation processor 110 sends the information for presentation on a display. In the examples described above, even though channels of I/Q data 116 have relatively low SNRs, remodulated reference I/Q data 150 has a relatively high SNR that exceeds the relatively low SNRs, which results in an increase in an accuracy of the TOAs, FOAs, TDOAs, FDOAs, and the geolocation.

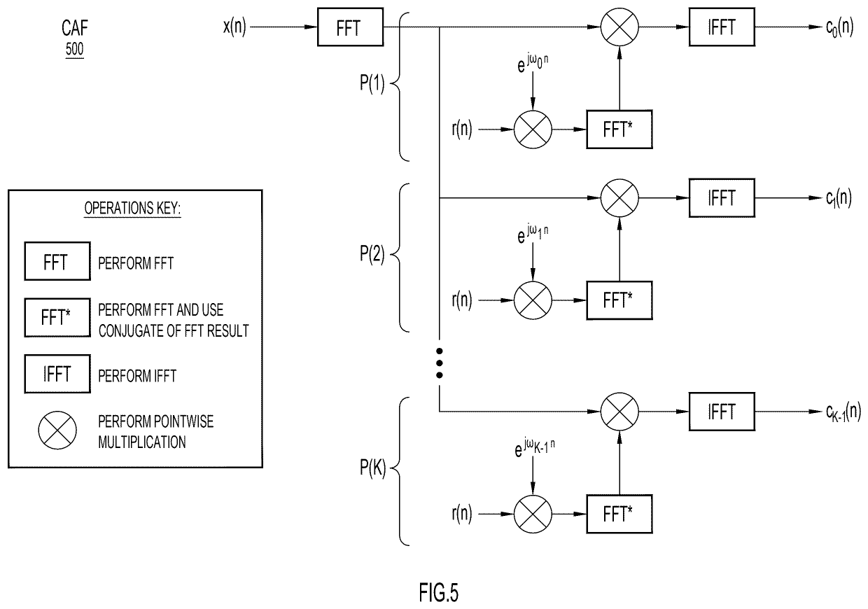

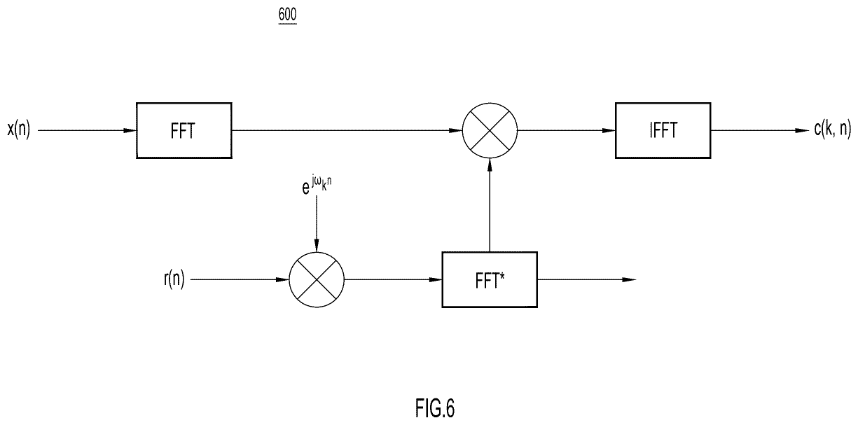

Example CAFs are described below in connection with FIGS. 5 and 6. FIG. 5 shows an example CAF 500 that operates on a channel of I/Q data x(n) (e.g., channel of I/Q data 116(i)) and remodulated reference I/Q data r(n) (i.e., remodulated reference I/Q data 150). Here “n” represents a time sample or index. Initially, the CAF generates an FFT of x(n) and supplies the FFT of x(n) to K correlation paths P(0)-P(K-1) in parallel. In parallel, the paths P(0)-P(K-1) perform respective correlations via FFT over k =0-(K-1) frequency shifts of the reference data r(n) (where k represents a frequency index), to produce respective correlation results c₀(n)-c_{K-1}(n).

More specifically, each correlation path P(i) (where i=0 to K−1) performs the following operations:
a. Apply frequency shift ωᵢ to r(n) to produce a frequency-shifted r(n) (i.e., r(n)·e^{jω,n}), and generate an FFT conjugate (FFT*) of the frequency-shifted r(n).
b. Pointwise multiply/correlate the (frequency-shifted) FFT conjugate against the FFT of x(n) to produce a correlation result, and generate an IFFT of the correlation result to produce cᵢ(n) in the time domain.

In an example in which modulated RF signal is centered at 2 GHz, relative movement or motion between RF collectors 106 and side-channel RF collector 108 may cause doppler shifts on the order of 200-300 Hz between remodulated reference I/Q data 150 (e.g., r(n)) and channels of I/Q data 116 (e.g., x(n)). Accordingly, correlating remodulated reference I/Q data 150 against the channels of I/Q data 116 over frequency (i.e., across multiple frequency shifts) accounts for the doppler shifts and ensures that the correlation results will include/capture doppler-shifted correlation peaks.

FIG. 6 shows an example generalized CAF 600 that performs separate correlations of demodulated reference r(n) against each channel of I/Q data x(n) over both frequency index k (i.e., frequency shifts k) and time sample n, to produce a CAF result c(k, n). The frequency shifts can be performed via circular shifts of reference FFT data, for example.

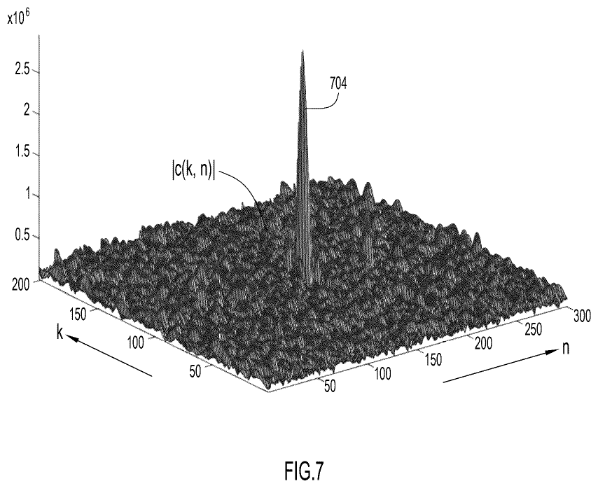

FIG. 7 shows an example of CAF result c(k, n). CAF result c(k, n) includes a three-dimensional (3D) surface |c(k, n)|, which includes the absolute value of correlations over time and frequency. CAF result c(k, n) includes a correlation peak 704 rising from a 2D surface/plane defined by time sample n and frequency index k axes. Correlation peak 704 is specifically indexed/located by a specific time sample (TOA) and frequency index (FOA) pair.

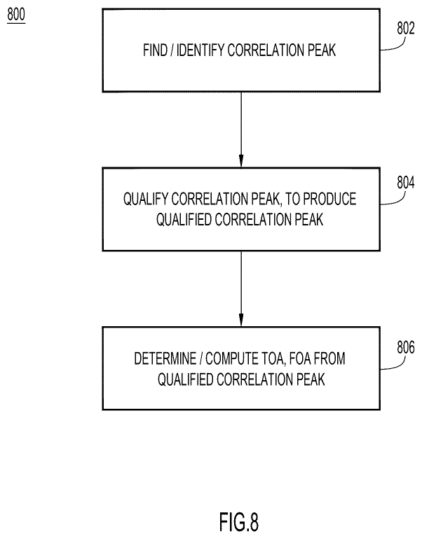

FIG. 8 shows example operations 800 (also referred to as “peak processing”) performed by geolocation processor 110 on N CAF results corresponding to N RF collectors 106. That is, geolocation processor 110 performs operations 800 on each CAF result.

At 802, the peak processing searches the CAF result/surface for a peak value that is a maximum.

Once the peak value is found, at 804, the peak processing qualifies the peak value using a statistical test. The statistical test establishes whether the peak value is a true peak value or just noise. First, the peak processing computes a mean and a standard deviation (std) of non-peak (noise) values. The non-peak values are CAF surface values not including those of a square or circular extraction around the peak. Second, peak processing computes a statistic (stat) equal to a number of noise floor standard deviations that the peak value is above the noise floor, as follow: Stat=(peak value−mean (non-peak values))/std (non-peak values).

Third, the peak processing determines whether stat exceeds a threshold. When stat exceeds the threshold, peak processing qualifies the peak value. When stat does not exceed the threshold, peak processing does not qualify the peak value.

At 806, the peak processing recovers a coarse TOA and a coarse FOA from the qualified peak value (only from qualified peak values). The coarse TOA represents a maximum over time index n, and the coarse FOA represents a maximum over frequency index k. Additionally, the peak value may be interpolated over both time and frequency, using polynomial fit or other subs-ample techniques.

Operations 800 produce/derive TOA, FOA pairs from corresponding ones of the CAF results. The TOAs and FOAs may be in units of seconds and Hz, respectively, given a known sample rate of received and reference data, a known time of a first sample of the received data, and known frequency shifts in Hz corresponding to mixes of references prior to the correlations.

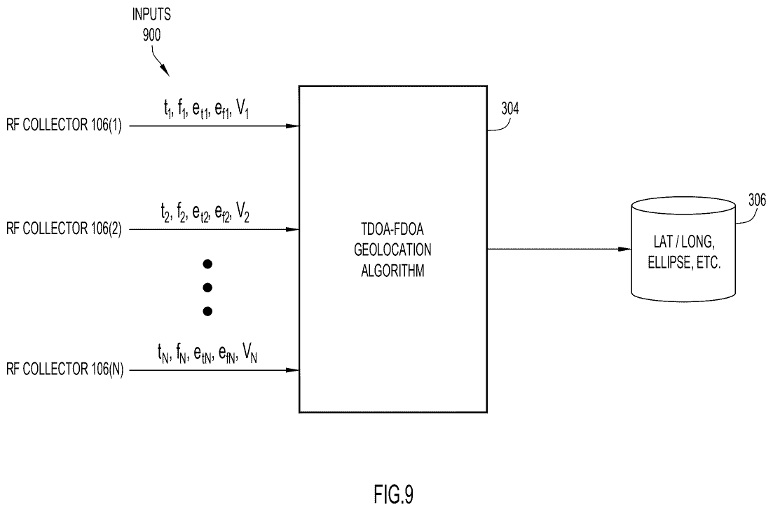

FIG. 9 shows inputs 900 to TDOA-FDOA geolocation algorithm 304. Inputs 900 include TOAs (t), FOAs (f), error estimates for the TOAs (eₜ), error estimates for the FOAs (e_{f}), and navigation data (NAV, V) corresponding to RF collectors 106. The algorithm may include any known or hereafter developed geolocation algorithm that geolocates a wireless transmitter based on TDOAs and FDOAs, including iterated least squares, Kalman filter, and so on. NAV may be interpolated at the TOA from NAV points corresponding to time before and after the TOA. Interpolation techniques may include linear interpolation, quaternion, orbit integration, and the like.

The above-mentioned errors on FOA and TOA values (e.g., standard deviation or variance on FOA/TOA estimation) can be calibrated for each RF collector using previously known performance of FOA/TOA estimation against collected transmissions for a truth emitter at a known location transmitting at known times and frequencies. The error estimates can be retrieved from a calibration table for future measurements. Error estimates on FOA/TOA values may be adjusted given peak statistics (e.g., a shorter peak in a CAF may be assigned a larger error variance than a measurement corresponding to a taller/higher peak in the CAF). The term “NAV” is shorthand for “navigation data,” which is associated with movement of an RF collector through space at discrete points in time. In an example, a navigation data vector V for a single RF collector includes six values: X, Y and Z (meters), comprising coordinates in an Earth-centered, Earth-fixed (ECEF) coordinate system; and X_dot, Y_dot and Z_dot (meters/second), comprising a velocity vector in X, Y and Z directions.

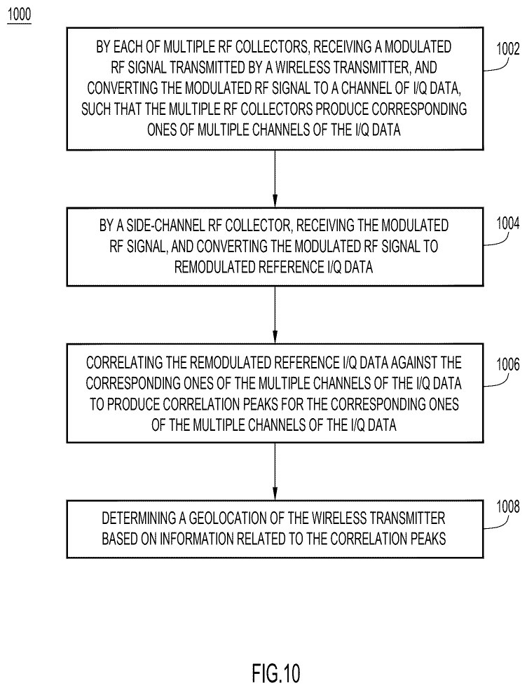

FIG. 10 is a flowchart of another example method 1000 of geolocating a wireless transmitter performed by a geolocation system (e.g., geolocation system 104).

1002 includes, by each of multiple RF collectors, receiving a modulated RF signal transmitted by the wireless transmitter, and converting the modulated RF signal to a channel of in-phase/quadrature (I/Q) data, such that the multiple RF collectors produce corresponding ones of multiple channels of the I/Q data. The converting does not include demodulating, such that the multiple channels of the I/Q data are modulated channels of I/Q data.

1004 includes, by a side-channel RF collector, receiving the modulated RF signal, and converting the modulated RF signal to remodulated reference I/Q data. Converting includes demodulating the modulated RF signal to produce demodulated reference I/Q data and remodulating the demodulated reference I/Q data. 1006 includes separately correlating (e.g., using a CAF) the remodulated reference I/Q data against the corresponding ones of the multiple channels of the I/Q data to produce correlation peaks indicative of pairs of TOAs and FOAs for the corresponding ones of the multiple channels of the I/Q data.

1008 includes determining a geolocation of the wireless transmitter based on information related to the correlation peaks. 1009 includes differencing the TOAs to produce TDOAs, differencing the FOAs to produce FDOAs, and geolocating based on the TDOAs and the FDOAs.

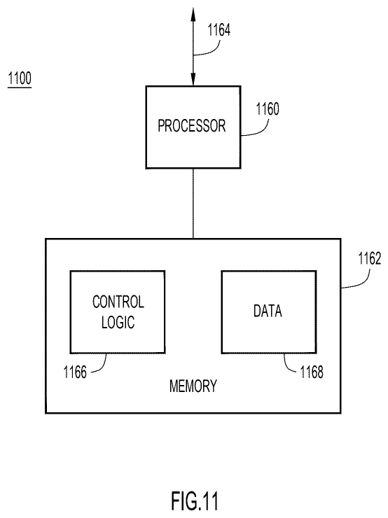

FIG. 11 is a block diagram of an example controller 1100 configured to perform operations (e.g., signal processing operations) described herein. Controller 1100 includes processor(s) 1160 and a memory 1162 coupled to one another. The aforementioned components may be implemented in hardware (e.g., a hardware processor), software (e.g., a software processor), or a combination thereof. Processor(s) 1160 receive digitized RF energy samples from ADCs in-line with the above-described received RF signals (e.g., ADC 202 for each received RF signal) over interfaces 1164, which may include hardware and/or software interfaces. Processor(s) 1160 communicate with other entities/processes over interfaces 1164, e.g., to provide TOAs and FOAs to a location engine, for example. Memory 1162 stores control software 1166 (referred as “control logic”), that when executed by the processor(s) 1160, causes the processor(s), and more generally, controller 1100, to perform the various operations described herein. The processor(s) 1160 may be a microprocessor or microcontroller (or multiple instances of such components). The memory 1162 may include read only memory (ROM), random access memory (RAM), magnetic disk storage media devices, optical storage media devices, flash memory devices, electrical, optical, or other physically tangible (i.e., non-transitory) memory storage devices. Controller 1100 may also be discrete logic embedded within an integrated circuit (IC) device.

Thus, in general, the memory 1162 may comprise one or more tangible (non-transitory) computer readable storage media (e.g., memory device(s)) including a first non-transitory computer readable storage medium, a second non-transitory computer readable storage medium, and so on, encoded with software or firmware that comprises computer executable instructions. For example, control software 1166 includes logic to implement operations performed by the controller 1100. For example, the logic may implement signal processor 122, collector receiver 112, and geolocation processor 110. Thus, control software 1166 implements the various methods/operations described herein.

In addition, memory 1162 stores data 1168 used and produced by control software 1166.

In some aspects, the techniques described herein relate to a method of geolocating a wireless transmitter, the method including: by each of multiple RF collectors, receiving a modulated RF signal transmitted by the wireless transmitter, and converting the modulated RF signal to a channel of in-phase/quadrature (I/Q) data, such that the multiple RF collectors produce corresponding ones of multiple channels of the I/Q data; by a side-channel RF collector, receiving the modulated RF signal, and converting the modulated RF signal to remodulated reference I/Q data; correlating the remodulated reference I/Q data against the corresponding ones of the multiple channels of the I/Q data to produce correlation peaks for the corresponding ones of the multiple channels of the I/Q data; and determining a geolocation of the wireless transmitter based on information related to the correlation peaks.

In some aspects, the techniques described herein relate to a method, wherein the multiple RF collectors are deployed on separate mobile platforms that are geographically separated from each other and are each geographically separated from a platform on which the side-channel RF collector is deployed.

In some aspects, the techniques described herein relate to a method, further including: by each of the multiple RF collectors, wireless transmitting the multiple channels of I/Q data; and after wireless receiving the multiple channels of the I/Q data, performing correlating.

In some aspects, the techniques described herein relate to a method, wherein converting includes: demodulating the modulated RF signal to produce a side-channel of the I/Q data; and remodulating the side-channel of the I/Q data to produce the remodulated reference I/Q data.

In some aspects, the techniques described herein relate to a method, wherein: converting further includes decoding the modulated RF signal to recover an identifier of the wireless transmitter that is conveyed in the modulated RF signal; and the method further includes outputting the geolocation with the identifier.

In some aspects, the techniques described herein relate to a method, wherein: correlating includes correlating without correlating any of the multiple channels of the I/Q data against each other.

In some aspects, the techniques described herein relate to a method, wherein: correlating includes correlating over time and frequency such that the correlation peaks indicate time-of-arrivals (TOAs) and frequency-of-arrivals (FOAs) for the corresponding ones of the multiple channels of the I/Q data; and determining the geolocation includes determining the geolocation based on the TOAs and the FOAs.

In some aspects, the techniques described herein relate to a method, wherein: the FOAs indicate doppler shifts between the multiple channels of the I/Q data and the remodulated reference I/Q data caused by relative motion between the multiple RF collectors and the side-channel RF collector.

In some aspects, the techniques described herein relate to a method, further including: performing correlating according to a complex ambiguity function.

In some aspects, the techniques described herein relate to a method, further including: identifying the correlation peaks produced by correlating; qualifying the correlation peaks using a statistical test to produce qualified correlation peaks; and determining the TOAs and the FOAs from the qualified correlation peaks.

In some aspects, the techniques described herein relate to a method, wherein determining the geolocation includes: differencing the TOAs to produce one or more time-difference-of-arrivals (TDOAs); differencing the FOAs to produce one or more frequency-difference-of-arrivals (FDOAs); and computing the geolocation based on the one or more TDOAs and the one or more FDOAs.

In some aspects, the techniques described herein relate to a method, wherein: the multiple channels of the I/Q data have relatively low signal-to-noise ratios (SNRs), respectively, and the remodulated reference I/Q data includes a relatively high signal-to-noise ratio (SNR) that exceeds each relatively low SNR, which results in an increase in an accuracy of the TOAs, the FOAs, and the geolocation.

In some aspects, the techniques described herein relate to a system for geolocating a wireless transmitter, the system including: multiple RF collectors each configured to perform receiving a modulated RF signal transmitted by the wireless transmitter, and converting the modulated RF signal to a channel of in-phase/quadrature (I/Q) data, such that the multiple RF collectors are configured to produce corresponding ones of multiple channels of the I/Q data; a side-channel RF collector to perform receiving the modulated RF signal, and converting the modulated RF signal to remodulated reference I/Q data; correlators to perform correlating the remodulated reference I/Q data against the corresponding ones of the multiple channels of the I/Q data to produce correlation peaks for the corresponding ones of the multiple channels of the I/Q data; and a geolocation processor to determine a geolocation of the wireless transmitter based on information related to the correlation peaks.

In some aspects, the techniques described herein relate to a system, wherein the multiple RF collectors are deployed on separate mobile platforms that are geographically separated from each other and separated from a platform on which the side-channel RF collector is deployed.

In some aspects, the techniques described herein relate to a system, wherein the side-channel RF collector is configured to perform converting by: demodulating the modulated RF signal to produce a side-channel of the I/Q data; and remodulating the side-channel of the I/Q data to produce the remodulated reference I/Q data.

In some aspects, the techniques described herein relate to a system, wherein: the side-channel RF collector is further configured to perform converting by decoding the modulated RF signal to recover an identifier of the wireless transmitter that is conveyed in the modulated RF signal; and the geolocation processor is configured to perform outputting the geolocation with the identifier.

In some aspects, the techniques described herein relate to a system, wherein: the correlators are configured to perform correlating by correlating without correlating any of the multiple channels of the I/Q data against each other.

In some aspects, the techniques described herein relate to a system, wherein: the correlators are configured to perform correlating by correlating over time and frequency such that the correlation peaks indicate time-of-arrivals (TOAs) and frequency-of-arrivals (FOAs) for the corresponding ones of the multiple channels of the I/Q data; and the geolocation processor is configured to perform determining the geolocation by determining the geolocation based on the TOAs and the FOAs.

In some aspects, the techniques described herein relate to a system, further including: identifying the correlation peaks produced by correlating; qualifying the correlation peaks using a statistical test to produce qualified correlation peaks; and determining the TOAs and the FOAs from the qualified correlation peaks.

In some aspects, the techniques described herein relate to a system, wherein the geolocation processor performs determining the geolocation by: differencing the TOAs to produce one or more time-difference-of-arrivals (TDOAs); differencing the FOAs to produce one or more frequency-difference-of-arrivals (FDOAs); and computing the geolocation based on the one or more TDOAs and the one or more FDOAs.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method of geolocating a wireless transmitter, the method comprising:
by each of multiple RF collectors, receiving a modulated RF signal transmitted by the wireless transmitter, and converting the modulated RF signal to a channel of in-phase/quadrature (I/Q) data, such that the multiple RF collectors produce corresponding ones of multiple channels of the I/Q data;
by a side-channel RF collector, receiving the modulated RF signal, and converting the modulated RF signal to remodulated reference I/Q data;
correlating the remodulated reference I/Q data against the corresponding ones of the multiple channels of the I/Q data to produce correlation peaks for the corresponding ones of the multiple channels of the I/Q data; and
determining a geolocation of the wireless transmitter based on information related to the correlation peaks.

2. The method of claim 1, wherein the multiple RF collectors are deployed on separate mobile platforms that are geographically separated from each other and are each geographically separated from a platform on which the side-channel RF collector is deployed.

3. The method of claim 2, further comprising:
by each of the multiple RF collectors, wireless transmitting the multiple channels of I/Q data; and
after wireless receiving the multiple channels of the I/Q data, performing correlating.

4. The method of claim 1, wherein converting includes:
demodulating the modulated RF signal to produce a side-channel of the I/Q data; and
remodulating the side-channel of the I/Q data to produce the remodulated reference I/Q data.

5. The method of claim 4, wherein:
converting further includes decoding the modulated RF signal to recover an identifier of the wireless transmitter that is conveyed in the modulated RF signal; and
the method further comprises outputting the geolocation with the identifier.

6. The method of claim 1, wherein:
correlating includes correlating without correlating any of the multiple channels of the I/Q data against each other.

7. The method of claim 1, wherein:
correlating includes correlating over time and frequency such that the correlation peaks indicate time-of-arrivals (TOAs) and frequency-of-arrivals (FOAs) for the corresponding ones of the multiple channels of the I/Q data; and
determining the geolocation includes determining the geolocation based on the TOAs and the FOAs.

8. The method of claim 7, wherein:
the FOAs indicate doppler shifts between the multiple channels of the I/Q data and the remodulated reference I/Q data caused by relative motion between the multiple RF collectors and the side-channel RF collector.

9. The method of claim 7, further comprising:
performing correlating according to a complex ambiguity function.

10. The method of claim 7, further comprising:
identifying the correlation peaks produced by correlating;
qualifying the correlation peaks using a statistical test to produce qualified correlation peaks; and
determining the TOAs and the FOAs from the qualified correlation peaks.

11. The method of claim 7, wherein determining the geolocation includes:
differencing the TOAs to produce one or more time-difference-of-arrivals (TDOAs);
differencing the FOAs to produce one or more frequency-difference-of-arrivals (FDOAs); and
computing the geolocation based on the one or more TDOAs and the one or more FDOAs.

12. The method of claim 7, wherein:
the multiple channels of the I/Q data have relatively low signal-to-noise ratios (SNRs), respectively, and the remodulated reference I/Q data includes a relatively high signal-to-noise ratio (SNR) that exceeds each relatively low SNR, which results in an increase in an accuracy of the TOAs, the FOAs, and the geolocation.

13. A system for geolocating a wireless transmitter, the system comprising:
multiple RF collectors each configured to perform receiving a modulated RF signal transmitted by the wireless transmitter, and converting the modulated RF signal to a channel of in-phase/quadrature (I/Q) data, such that the multiple RF collectors are configured to produce corresponding ones of multiple channels of the I/Q data;
a side-channel RF collector to perform receiving the modulated RF signal, and converting the modulated RF signal to remodulated reference I/Q data;
correlators to perform correlating the remodulated reference I/Q data against the corresponding ones of the multiple channels of the I/Q data to produce correlation peaks for the corresponding ones of the multiple channels of the I/Q data; and
a geolocation processor to determine a geolocation of the wireless transmitter based on information related to the correlation peaks.

14. The system of claim 13, wherein the multiple RF collectors are deployed on separate mobile platforms that are geographically separated from each other and separated from a platform on which the side-channel RF collector is deployed.

15. The system of claim 13, wherein the side-channel RF collector is configured to perform converting by:
demodulating the modulated RF signal to produce a side-channel of the I/Q data; and
remodulating the side-channel of the I/Q data to produce the remodulated reference I/Q data.

16. The system of claim 15, wherein:
the side-channel RF collector is further configured to perform converting by decoding the modulated RF signal to recover an identifier of the wireless transmitter that is conveyed in the modulated RF signal; and
the geolocation processor is configured to perform outputting the geolocation with the identifier.

17. The system of claim 13, wherein:
the correlators are configured to perform correlating by correlating without correlating any of the multiple channels of the I/Q data against each other.

18. The system of claim 13, wherein:
the correlators are configured to perform correlating by correlating over time and frequency such that the correlation peaks indicate time-of-arrivals (TOAs) and frequency-of-arrivals (FOAs) for the corresponding ones of the multiple channels of the I/Q data; and
the geolocation processor is configured to perform determining the geolocation by determining the geolocation based on the TOAs and the FOAs.

19. The system of claim 18, further comprising:
identifying the correlation peaks produced by correlating;
qualifying the correlation peaks using a statistical test to produce qualified correlation peaks; and
determining the TOAs and the FOAs from the qualified correlation peaks.

20. The system of claim 18, wherein the geolocation processor performs determining the geolocation by:
differencing the TOAs to produce one or more time-difference-of-arrivals (TDOAs);
differencing the FOAs to produce one or more frequency-difference-of-arrivals (FDOAs); and
computing the geolocation based on the one or more TDOAs and the one or more FDOAs.
